(19) United States
(12) Patent Application Publication
(10) Pub. No.: US 2021/0218091 A1
(43) Pub. Date: Jul. 15, 2021

(54) INTERMEDIATE TEMPERATURE ALKALI METAL/OXYGEN BATTERIES EMPLOYING MOLTEN NITRATE ELECTROLYTES

(71) Applicant: LIOX POWER, INC., Pasadena, CA (US)

(72) Inventors: JASMIN UDDIN, PASADENA, CA (US); DAN D. ADDISON, PASADENA, CA (US); VINCENT GIORDANI, PASADENA, CA (US)

(21) Appl. No.: 17/211,755

(22) Filed: Mar. 24, 2021

Related U.S. Application Data
(63) Continuation of application No. 14/778,994, filed on Sep. 21, 2015, now abandoned.
(60) Provisional application No. 61/804,165, filed on Mar. 21, 2013.

(51) Int. Cl. H01M 12/08; H01M 4/36; H01M 4/134; H01M 10/0562; H01M 12/06; H01M 4/38; H01M 4/86

(52) U.S. Cl. CPC H01M 12/08; H01M 4/366; H01M 4/134; H01M 2300/0062; H01M 12/06; H01M 4/381; H01M 4/8605; H01M 10/0562

(57) ABSTRACT

High capacity alkali metal/oxygen batteries, e.g. Li/O₂ batteries, employing molten salt electrolytes comprising alkali metal cations and nitrate anions are disclosed. Batteries of the present invention operate at an intermediate temperature ranging from 80° C. to 250° C. Molten alkali metal nitrate electrolytes employed in O₂ electrodes within this temperature range provide alkali metal/oxygen batteries having significantly improved efficiency and rechargeability compared to prior art systems.

### CROSS-REFERENCES TO RELATED APPLICATIONS

The present application claims the benefit of the earlier filing date of U.S. Patent Application No. 61/804,165, filed on Mar. 21, 2013, the content of which is hereby incorporated by reference herein in its entirety.

### FIELD OF THE INVENTION

The present invention relates generally to high capacity batteries comprising alkali metal negative electrodes and O₂ positive electrodes. The invention also relates to molten salt electrolytes that allow efficient cycling of O₂ electrodes within such batteries. Furthermore, the invention relates to methods of operating rechargeable batteries having alkali metal negative electrodes, O₂ electrodes and molten salt electrolytes within an intermediate temperature range that is beneficial for the performance of such batteries.

### BACKGROUND OF THE INVENTION

Batteries are electrochemical cells configured to store and release energy. For simplicity, the term “battery” is used herein to refer to electrochemical energy storage devices comprising a single cell or plurality of cells. Primary batteries convert chemical energy to electric work in a single discharge, while secondary or rechargeable batteries may be discharged and charged multiple times. Improved batteries may enable advancements in other fields of technology requiring energy storage functionality.

The quantity of energy stored in a battery may be expressed per unit mass (“specific energy”) or volume (“energy density”). Considerable interest is directed toward the development of rechargeable batteries yielding higher specific energy and energy density than state-of-the-art Li-ion batteries. Motivating this interest is the goal of producing long range electric vehicles as a substitute for gasoline-powered vehicles. Current Li-ion batteries exhibit practical capacities nearing theoretical limits, thus realization of energy storage required to significantly extend the range of electric vehicles depends on the development of new electrochemical systems having higher theoretical specific energy and energy density. While the limitations of current electric vehicles exemplify the need for improved battery technology, this need arises similarly in numerous areas of human interest.

It has long been known that batteries having very high theoretical specific energy and energy density can be formed by the coupling of a metal negative electrode and an O₂ positive electrode. The terms “metal/air” and “metal/O₂” are both used to refer to such batteries. Logically, the former may refer to batteries that exchange O₂ (and possibly H₂O) with the ambient atmosphere through a gas diffusion electrode, whereas the latter may also encompass batteries that store O₂ internally. For the purpose of the present invention, the term “metal/O₂” refers to both internally-stored and ambient air-derived O₂. Li/O₂ batteries are particular attractive targets as high energy cells since Li metal has a very high specific capacity (3862 mAh/g) and low potential (−3.05 V vs. standard hydrogen electrode).

Efforts to develop Li/O₂ batteries for practical purposes have occurred sporadically since the early 1970's (see, e.g., U.S. Pat. No. 3,625,769). A variety of formats for Li/O₂ batteries have been disclosed which are conveniently classified according to the composition and configuration of the electrolyte or, relatedly, to the electrochemical reactions governing the O₂ positive electrode. According to this latter classification scheme, Li/O₂ batteries using protic or aqueous electrolytes in the O₂ positive electrode are defined by the electrode reaction:

4Li⁺+2H₂O+O₂+4e⁻→4LiOH 1)

Alternatively, Li/O₂ batteries employing aprotic or non-aqueous electrolytes in the O₂ positive electrode are defined by electrode reactions involving either two or four electron reductions of O_{2:}

2Li⁺+O₂+2e⁻→Li₂O₂ 2)

4Li⁺+O₂+4e→2Li₂O 3)

Reactivity between Li metal negative electrodes and aqueous electrolytes initially was thought to preclude the development of rechargeable aqueous Li/O₂ cells, although primary aqueous Li/O₂ cells were investigated (see, e.g., Momyer W R, Morris J L. 1979. Reactive Metal-Air Batteries for Automotive Propulsion: Final Report, Aug. 1, 1978-Nov. 30, 1979, Palo Atlo (Calif.): Lockheed Palo Alto Research Laboratory, Technical Report No. LMSC-D-683375). Protected Li electrode technology was conceived as a strategy for employing both aqueous and aprotic electrolytes that are reactive with Li metal in rechargeable Li/O₂ batteries, as disclosed in, for example, U.S. Pat. Nos. 7,491,458 and 8,652,692, which are incorporated by reference herein in their entireties. Cells configured with protected Li electrodes employ a solid ceramic membrane interposed between the Li electrode and the positive electrode compartment. The ceramic membrane is conductive to Li ions but is otherwise substantially impermeable, thus confining contents of the positive electrode compartment and preventing reaction with Li metal negative electrodes. Other approaches to the electrolyte in Li/O₂ batteries have included the use of organic electrolytes such as polymers, organic solvents or ionic liquids (See, e.g., U.S. Pat. No. 5,510,209) or all solid-state electrolytes (See, e.g., U.S. Pat. No. 7,211,351).

Rechargeable Li/O₂ batteries of the prior art do not exhibit practical levels of performance. This proposition applies generally to all formats of Li/O₂ batteries disclosed to-date, including all classes of electrolyte (i.e. aqueous, organic and solid-state). Issues include low cycle life, rapid irreversible loss of active materials, low power output and very high overpotential, particularly during cell charging, equating to low energy efficiency for cell cycling. Limitations of prior art electrolytes in relation to O₂ positive electrodes contribute to these performance problems and are enumerated below.

1) Volatility: Volatile liquid electrolytes, including both aqueous electrolytes and organic electrolytes, evaporate from O₂ positive electrodes that are open to ambient atmosphere. The need to compensate for evaporative loss of volatile electrolytes represents a significant challenge hindering practical use of Li/O₂ batteries employing such electrolytes.

2) Chemical instability: Decomposition of organic electrolytes occurs within O₂ electrodes. Parasitic reactions between aprotic, organic electrolytes and reactive O₂ species include nucleophilic attack, proton abstraction and autoxidation and cause loss of electrolyte, formation of side products and eventual Li/O₂ cell failure. Analysis based on electrochemical mass spectrometry and other analytical methods has demonstrated decomposition of all classes of organic electrolytes that have been previously investigated for use in Li/O₂ batteries (See, e.g., Luntz A C and McCloskey B D. Non-aqueous Li-air Batteries: A Status Report, Chem. Rev. (2014)). These include carbonates, ethers (including polymers based on polyethylene oxide), esters, lactones, sulfones, sulfamides, sulfoxides, nitriles, amides and room temperature ionic liquids. Regarding this latter class, room temperature ionic liquids exhibit negligible vapor pressure and have been proposed to circumvent evaporative loss of the electrolyte, but the reactivity of organic cations of ionic liquids with O₂ reduction products similarly hinders their use in practical rechargeable Li/O₂ cells.

3) Insolubility of discharge products: The properties of lithium oxides formed during cell discharge in prior art electrolytes also limit performance. Both Li₂O₂ and Li₂O are electronically insulating in the bulk phase and are highly insoluble in organic electrolytes. Poor electron transport combined with low solubility causes capacity limitations and high overpotential observed during cell charging in both organic electrolyte and all solid-state Li/O₂ batteries.

4) Reactivity with ambient air: Still another challenge relates to the effect on the electrolyte of H₂O and CO₂ present in O₂ obtained from ambient atmosphere. The presence of CO₂ in the O₂ electrode of both aqueous and aprotic Li/O₂ cells causes the formation of Li₂CO₃, which accumulates irreversibly in the pores of the O₂ positive electrode leading to eventual cell failure. The resulting need to process the intake gas with a CO₂ scrubber increases system-level complexity and the budget of inactive material mass. The presence of water is also known to accelerate decomposition processes occurring in organic electrolytes within O₂ positive electrodes.

In addition to the preceding electrolyte problems, another challenge in Li/O₂ battery development relates to the formation of dendrites on the Li electrode during cycling. Dendrites are morphological features of deposited Li metal that grow into the electrolyte and may cause short circuiting if contact is made with the positive electrode. In protected Li electrodes, dendrite growth may deleteriously impact the stability of the ceramic membrane that separates the Li electrode from the positive electrode compartment.

In light of the foregoing, solutions must be found to the preceding problems in order to advance rechargeable Li/O₂ battery technology to a point of practical applicability. Such solutions may enable rechargeable batteries having enhancements relative to state-of-the-art Li-ion batteries.

### SUMMARY OF THE INVENTION

An embodiment of the invention relates to an alkali metal/O₂ battery comprising an alkali metal negative electrode, an O₂ positive electrode and a molten salt electrolyte comprising alkali metal cations and nitrate anions. In certain embodiments, the alkali metal/O₂ battery operates at a temperature greater than or equal to 80° C. and less than or equal to 250° C. In preferred embodiments, the alkali metal negative electrode comprises Li. In other embodiments, the alkali metal negative electrode comprises Na.

In certain embodiments, the molten salt electrolyte comprises binary, ternary or quarternary mixtures of LiNO₃, NaNO₃, KNO₃ and CsNO₃. In some embodiments, the molten salt electrolyte further comprises nitrite anions.

In certain embodiments, the O₂ positive electrode comprises a porous, electronically conducting material. In some embodiments, the O₂ positive electrode comprises an electronically conducting metal oxide. In some embodiments, the O₂ positive electrode comprises an electronically conducting metal carbide. In some embodiments, the O₂ positive electrode comprises a transition metal selected from the group consisting of Ir, Pt and Au. In some embodiments, the O₂ positive electrode comprises diamond doped with boron, phosphorus or nitrogen. In some embodiments, the partial pressure of O₂ within the O₂ positive electrode is maintained at greater than or equal to 2 atm, greater than or equal to 20 atm or greater than or equal to 150 atm. In some embodiments, the potential of the O₂ positive electrode is maintained at greater than or equal to 2.0 V, greater than or equal to 2.2 V, greater than or equal to 2.4 V or greater than or equal to 2.6 V vs. Li⁺/Li.

In certain embodiments, an interlayer comprising a solid ceramic membrane is positioned to prevent contact between the alkali metal negative electrode and molten salt electrolyte. In some embodiments, the solid ceramic membrane is selected from the group consisting of LISICON and garnet-type ceramics. In other embodiments, the solid ceramic membrane is selected from the group consisting of NASICON and sodium beta alumina.

Another embodiment of the invention relates to a method of operating a battery comprising a Li metal negative electrode and an electrolyte, wherein the method comprises heating the Li metal negative electrode to an annealing temperature at which dendrites are not formed or are removed. In some embodiments, the annealing temperature is greater than or equal to 160° C. and less than or equal to 200° C. In some embodiments, an interlayer covers the Li metal negative electrode facing the electrolyte and comprises a fully reduced material selected from the group consisting of nitrides, phosphides, oxides, sulfides and halides.

### BRIEF DESCRIPTION OF THE FIGURES

FIG. 1 depicts a schematic drawing of a cross sectional view of an alkali metal/O₂ battery (not drawn to scale) in accordance with the present invention.

FIG. 2 depicts a thermogravimetric plot of temperature vs. mass performed on a sample containing Li₂O₂ and a binary mixture of LiNO₃ and KNO₃ in accordance with the present invention.

FIG. 3 depicts a plot of voltage vs. discharge capacity per gram of carbon of an Li/O₂ cell employing an electrolyte comprising a binary mixture of LiNO₃ and KNO₃ and cycled at a temperature of 150° C. in accordance with the present invention.

FIG. 4 depicts a plot of voltage and pressure variation vs. time of an Li/O₂ cell employing an electrolyte comprising a binary mixture of LiNO₃ and KNO₃ and cycled at a temperature of 150° C. within a hermetically sealed fixture in accordance with the present invention.

### DETAILED DESCRIPTION OF THE INVENTION

Embodiments of the invention are described in detail with reference to figures. Specific embodiments are provided for illustration and are non-limiting. Less detail is provided for established art involved in practicing the invention to avoid obscuring novel and non-obvious features.

The present invention provides high specific energy and energy density rechargeable batteries comprising alkali metal negative electrodes and O₂ positive electrodes. Beneficial aspects of the present invention are achieved by the use of molten salts comprising alkali metal cations and nitrate anions as electrolytes in alkali metal/O₂ batteries that operate within an intermediate temperature range.

For the purpose of the present invention, the term “intermediate temperature” refers to temperatures greater than ambient temperature but low enough to be practically attainable in many applications such as, for example, electric vehicles. Specifically, liquidus temperatures of molten salt electrolytes employed in present invention define the lower limit of intermediate temperature operation as conceived herein. Preferably this operating temperature ranges from 80° C. to 250° C. In the present invention, the intermediate temperature of operation and the beneficial properties of molten salt electrolytes comprising alkali metal cations and nitrate anions vis a vis the O₂ electrode provide solutions to the problems encountered in prior art alkali metal/O₂ batteries, specifically Li/O₂ batteries, set forth in the BACKGROUND OF THE INVENTION.

The invention specifically comprehends both intermediate temperature Li/O₂ and Na/O₂ batteries employing molten alkali metal nitrate electrolytes. For explanatory simplicity, embodiments described in detail herein relate primarily to Li/O₂ batteries. Additionally, batteries of the present invention are preferably rechargeable, though it is contemplated that intermediate temperature primary alkali metal/O₂ batteries employing alkali metal nitrate electrolytes are encompassed within the scope of the invention and may have beneficial features compared to prior art primary batteries.

Molten salts comprising mixtures of alkali metal nitrates are utilized in a variety of technological applications. Useful properties exhibited by molten alkali metal nitrates include low melting point, stability at high temperature, stability in contact with air, low viscosity, low cost, low corrosiveness to typical container materials, low vapor pressure and high heat capacity. Consequently, they are used as heat transfer fluids for solar thermal energy systems (See, e.g., U.S. Pat. No. 7,588,694) and as a working fluid for an industrial process for the chemical separation of O₂ from ambient air (see, e.g., U.S. Pat. No. 4,132,766). Thermal batteries have been described that use molten nitrates as electrolytes with Li or Ca negative electrodes and transition metal positive electrodes and are disclosed in U.S. Pat. Nos. 4,190,704, 4,315,059 and 4,416,958, all of which are incorporated by reference herein in their entireties.

Benefits of intermediate temperature operation and molten alkali metal nitrates electrolytes in Li/O₂ batteries can be understood in relation to problems with prior art electrolytes (i.e. aqueous, organic and all solid-state) listed above. Volatility: The vapor pressure of molten alkali metal nitrates is negligible and thus evaporative electrolyte loss is mitigated in Li/O₂ batteries of the present invention. Chemical instability: The lack of organic materials in molten alkali metal nitrates of the present invention eliminates parasitic reactions and associated performance losses encountered when using organic electrolytes. Molten alkali metal nitrates are chemically inert toward electrochemical processes in the O₂ electrode. Insolubility of discharge products: In contrast to prior art aprotic electrolytes, Li₂O₂ and Li₂O are comparatively soluble in molten alkali metal nitrates within the intermediate temperature range of cell operation. Solubility of discharge products provides a pathway for charge transport via diffusion that circumvents ohmic losses observed in the bulk solids. Consequently, high overpotential and voltage hysteresis caused by ohmic losses observed during charging of prior art Li/O₂ batteries is substantially reduced in the present invention. Reactivity with ambient air: CO₂ and H₂O entering O₂ electrodes containing molten alkali metal nitrates still may cause the formation of Li₂CO₃ and LiOH, but in contrast to prior art Li/O₂ batteries, these products have meaningful solubility and can be electrochemically oxidized in molten alkali metal nitrates at potentials near thermodynamic standard potentials. Therefore, irreversible accumulation of these products in Li/O₂ batteries of the present invention may be avoided. Generally speaking, the operation of Li/O₂ batteries at intermediate temperature as contemplated in the present invention permits the use of stable, nonvolatile inorganic liquid electrolytes and additionally enables enhanced electrode kinetics, fast ionic conductivity and low voltage hysteresis relative to prior art Li/O₂ batteries.

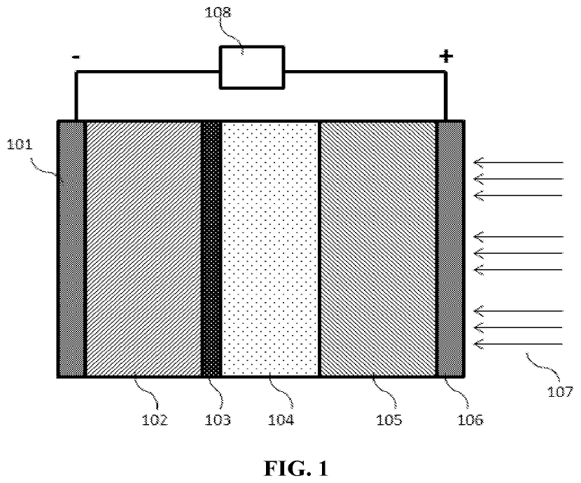

Referring now to FIG. 1, an alkali metal/O₂ cell having a molten salt electrolyte comprising alkali metal cations and nitrate anions is depicted in accordance with a preferred embodiment of the invention. The cell includes an alkali metal negative electrode 102 and an O₂ positive electrode 105 configured to exchange O₂ with an external source 107. The alkali metal negative electrode 102 and O₂ positive electrode 105 are connected via two pathways, the first of which is an electrolyte comprising molten alkali metal cations and nitrate anions 104 and a solid interlayer 103 separating the alkali metal negative electrode and the molten salt electrolyte. The second pathway connects current collectors for the negative and positive electrode (101 and 106, respectively) via an external circuit 108. In order to initiate cell operation, the internal temperature is brought and maintained above the liquidus temperature of the molten salt electrolyte. Methods of temperature control for the present invention are not particularly limited and may include, for example, resistive heating elements. During the discharging process, the alkali metal negative electrode is electrochemically oxidized. A cell voltage determined by the potential difference between the alkali metal negative electrode and O₂ positive electrode drives alkali metal cations and electrons through electrolyte layers and the external circuit, respectively. O₂ gas entering the O₂ positive electrode from the external source is electrochemically reduced and alkali metal oxide discharge products accumulate. Reverse processes occur during cell charging. An applied current or potential causes alkali metal oxides deposited in the O₂ electrode to be electrochemically oxidized. Alkali metal cations and electrons return to the alkali metal negative electrode through the electrolyte layers and external circuit, respectively. O₂ gas generated from the electrochemical oxidation of alkali metal oxides in the O₂ positive electrode is released into the external source. The alkali metal negative electrode is reconstituted via electrochemical reduction of alkali metal cations.

Referring back to FIG. 1, the molten salt electrolyte 104 comprises alkali metal cations and nitrate anions in a mixture preferably having a liquidus temperature greater than or equal to 80° C. and less than or equal to 250° C. Such mixtures may comprise binary, ternary or quarternary mixtures of alkali metal nitrates including LiNO₃, NaNO₃, KNO₃ and CsNO₃. Additionally the molten salt electrolyte optionally comprises nitrite anions. An exemplary molten salt electrolyte of the present invention is a eutectic consisting of LiNO₃, KNO₃ and CsNO₃ combined in a ratio of 37:39:24 mole percent and having a melting point of 97° C. (Janz G J, Allen C B, Bansal N P, Murphy R M and Tompkins R P T. 1978. Physical Properties Data Compilations Relevant to Energy Storage 1: Molten Salts: Eutectic Data, U.S. Department of Commerce, Technical Report No. NSRDS-NBS-61, which is incorporated by reference herein in its entirety).

Referring back to FIG. 1, the O₂ positive electrode 105 is preferably formed from a porous, electronically conductive material. The molten salt electrolyte partially fills the pores of the positive electrode, with remaining pores filled with O₂ gas (or air). Exemplary O₂ positive electrode materials include carbon black and carbon nanotubes. Other electrode materials may be chosen due to enhanced stability or catalytic activity toward O₂ electrode processes. O₂ electrode materials having enhanced stability may include electronically conducting metal oxides (e.g. perovskite oxides, Ti₄O₇ etc.), electronically conducting metal carbides (e.g. TiC, WC etc.), transition metals (e.g. Ir, Pt, Au etc.) and diamond doped with boron, phosphorous or nitrogen. In certain embodiments, O₂ entering the positive electrode is maintained at an elevated partial pressure relative to the ambient environment in order to provide performance benefits such as enhanced capacity, higher voltage or higher power output. Elevated O₂ partial pressures include greater than or equal to 2 atm, greater than or equal to 20 atm or greater than or equal to 150 atm. In embodiments with Li metal negative electrodes, the potential of the O₂ positive electrode is maintained at greater than or equal to 2.0 V, greater than or equal to 2.2 V, greater than or equal to 2.4 V or greater than or equal to 2.6 V vs. Li⁺/Li. Reduction of the nitrate anion likely occurs according to the following reaction:

2Li⁺+LiNO₃+2e⁻→LiNO₂+Li₂O 4)

The thermodynamic standard potential of this reaction is 2.42 V vs. Li⁺/Li at 150° C. In certain embodiments, the potential of the O₂ positive electrode is maintained above the potential for nitrate reduction. In such embodiments, electrode materials may be employed that have a high overpotential for reaction (4) in order to extend the operating potential window of the O₂ positive electrode. In different embodiments, the potential of the O₂ electrode is not limited and electrochemical reduction of nitrate anions may occur according to reaction (4). The use of nitrate as a positive electrode active material in thermal batteries has been disclosed in U.S. Pat. No. 4,260,667, which is incorporated by reference herein in its entirety. The electrochemical reduction of nitrate is highly irreversible, which heretofore limited the use of nitrate positive electrodes to primary batteries. In contrast, a continuous supply of O₂ gas being fed to the O₂ positive electrode in batteries of the present invention allows the following thermodynamically favorable reaction to occur in principle:

LiNO₂+½O₂→LiNO₃ 5)

Notably, the sum of reaction (4) and reaction (5) is reaction (3), or the four electron reduction of O₂ in the presence of Li cations. Thus, in certain embodiments, the nitrate anion may serve as a redox catalyst for the electrochemical reduction of O₂. In such embodiments, materials that are catalytic toward reaction (5) may be employed either as heterogeneous catalysts or electrolyte additives in the O₂ electrode.

Referring back to FIG. 1, the alkali metal negative electrode 102 comprises either Li or Na, most preferably Li. The term “alkali metal negative electrode” refers to negative electrode materials comprising the alkali metal in elemental form, but also to alloys or composites containing the alkali metal and other materials. A preferred embodiment of the invention employs Li metal as the alkali metal negative electrode. Other embodiments of the invention employ Na metal as the alkali metal negative electrode. The interlayer 103 positioned between the alkali metal negative electrode 102 and the molten salt electrolyte 104 is composed of a material that substantially inhibits reaction between the negative electrode and electrolyte. In certain embodiments, the interlayer material consists of a solid electrolyte interphase formed in situ by the reaction between the electrolyte and the alkali metal negative electrode. More preferably, the interlayer comprises a solid ceramic membrane that is conductive toward the active alkali metal cation but is substantially inert toward the molten nitrate electrolyte and operating environment contained within the O₂ positive electrode. For Li/O₂ cells of the present invention, suitable solid ceramic membrane materials include LISICON or garnet-type ceramics. For Na/O₂ cells of the present invention, suitable solid ceramic membrane materials include NASICON or sodium beta alumina. The invention further contemplates a method for cycling Li metal that substantially inhibits dendrite growth. The method comprises heating the Li electrode to an annealing temperature at which dendrite growth does not occur or at which dendrites are removed. Typically, the annealing temperature is between 160° C. and 200° C. This method is particularly effective when Li metal is covered in an interlayer comprising a fully reduced material, e.g. nitrides, oxides, phosphides, sulfides or halides of alkali metals.

### EXAMPLE 1

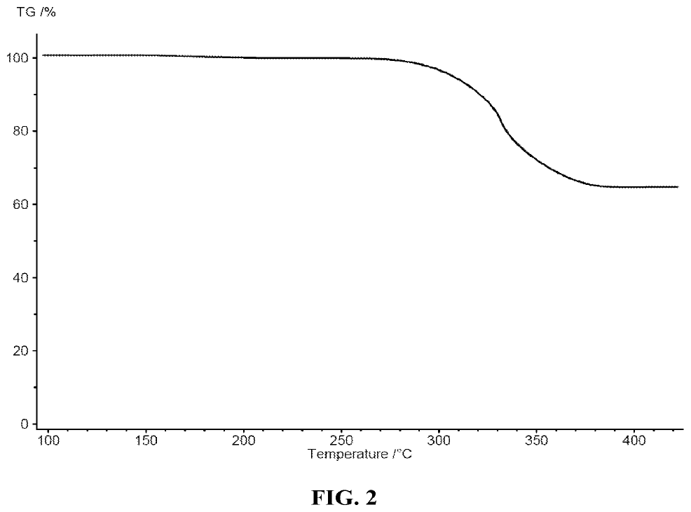

Inertness of electrolyte: In this example (FIG. 2), thermogravimetric analysis is performed in order to ascertain reactivity between an electrolyte comprising molten alkali metal nitrates and Li₂O₂, which may be formed in the O₂ positive electrode in accordance with the present invention. A sample was prepared consisting of a eutectic mixture of LiNO₃ and KNO₃ in a ratio of 42:58 mole percent and having a melting point of 124 C. An amount of Li₂O₂ was added to the sample which was then heated to above 400° C. at a rate of 20° C./minute. Thermal decomposition of Li₂O₂ occurs according to the reaction: Li₂O₂→Li₂O+½O₂. From this reaction a theoretical mass loss of 35% is predicted. FIG. 2 depicts a plot of mass change vs. temperature for this experiment. Observation of a mass loss of 35% of the starting Li₂O₂ mass beginning at 300° C., approximately the expected temperature of Li₂O₂ thermal decomposition, provides evidence that no reaction occurred between Li₂O₂ and the electrolyte over the temperature range of the experiment.

### EXAMPLE 2

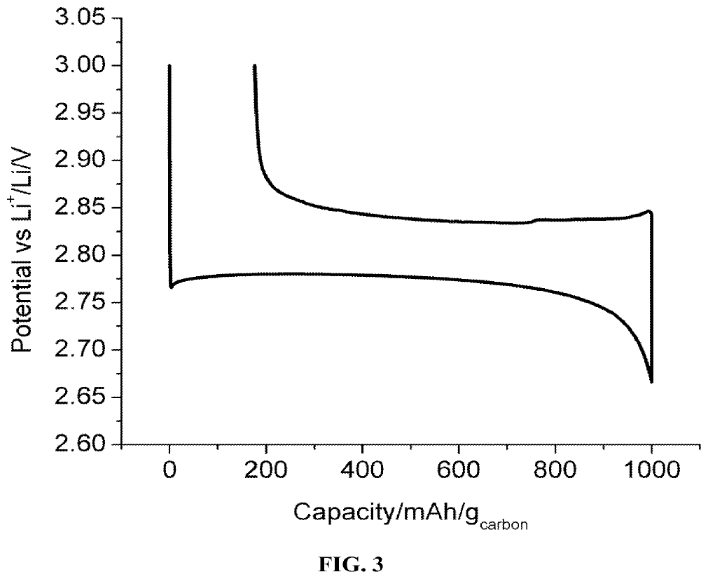

High capacity and low voltage hysteresis: In this example (FIG. 3), a Li/O₂ cell employing a molten alkali metal nitrate electrolyte is cycled at intermediate temperature in accordance with the present invention. A cell was assembled consisting of a 1 cm diameter, 250 micron thick Li metal electrode, an O₂ electrode formed from 5 mg Super P carbon:PTFE mix (90:10 weight percent carbon) dry pressed onto a stainless steel 316 mesh and approximately 150 μL of LiNO₃—KNO₃ eutectic electrolyte impregnated in a Whatman glass filter separator. The cell is cycled under O₂ at a current density of 50 mA/g of carbon and at a temperature of 150° C. A high capacity of 1000 mAh/g of carbon is achieved on discharge with low polarization. Unlike prior art Li/O₂ batteries, charging overpotential is extremely low (<50 mV) and nearly symmetric with discharge overpotential. Coulombic efficiency of approximately 84% is observed from discharge to charge. Dissolution of Li₂O₂ formed in the O₂ electrode followed by diffusion to and reduction on the unprotected Li electrode is hypothesized to cause Coulombic loss.

### EXAMPLE 3

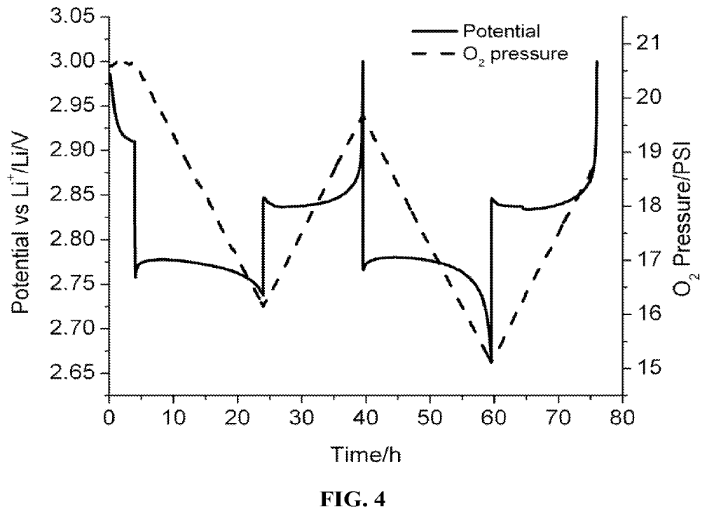

Theoretically predicted O₂ utilization: This example (FIG. 4) demonstrates the stability of the molten alkali metal nitrate electrolyte in Li/O₂ cells in accordance with the present invention. A cell was assembled and cycled inside a hermetically sealed vessel filled with O₂ according to the procedure of Example 2. In situ monitoring of pressure variation was performed during cycling. Two electrons per mole of O₂ gas consumed is calculated from pressure and coulometry data, corresponding to the theoretically predicted value from reaction (2).

1. An alkali metal/O₂ battery comprising:
a) an alkali metal negative electrode;
b) an O₂ positive electrode;
c) a molten salt electrolyte comprising alkali metal cations and nitrate anions.

2. The battery of claim 1, wherein the battery operates at a temperature greater than or equal to 80° C. and less than or equal to 250° C.

3. The battery of claim 1, wherein the alkali metal negative electrode comprises Li.

4. The battery of claim 1, wherein the alkali metal negative electrode comprises Na.

5. The battery of claim 1, wherein the molten salt electrolyte comprises binary, ternary or quarternary mixtures of LiNO₃, NaNO₃, KNO₃ and CsNO₃.

6. The battery of claim 1, wherein the molten salt electrolyte comprises nitrite anions.

7. The battery of claim 1, wherein the O₂ positive electrode comprises a porous, electronically conducting material.

8. The battery of claim 1, wherein the O₂ positive electrode comprises an electronically conducting metal oxide.

9. The battery of claim 1, wherein the O₂ positive electrode comprises an electronically conducting metal carbide.

10. The battery of claim 1, wherein the O₂ positive electrode comprises a transition metal selected from the group consisting of Ir, Pt and Au.

11. The battery of claim 1, wherein the O₂ positive electrode comprises diamond doped with boron, phosphorus or nitrogen.

12. The battery of claim 1, wherein O₂ is supplied to the positive electrode at a partial pressure greater than or equal 2 atm, greater than or equal to 20 atm or greater than or equal to 150 atm.

13. The battery of claim 1, wherein the potential of the O₂ positive electrode is maintained at greater than or equal to 2.0 V, greater than or equal to 2.2 V, greater than or equal to 2.4 V or greater than or equal to 2.6 V vs. Li⁺/Li.

14. The battery of claim 1, wherein an interlayer comprising a solid ceramic membrane is positioned to prevent contact between the alkali metal negative electrode and molten salt electrolyte.

15. The battery of claim 14, wherein the solid ceramic membrane is selected from the group consisting of LISICON and garnet-type ceramics.

16. The battery of claim 14, wherein the solid ceramic membrane is selected from the group consisting of NASICON and sodium beta alumina.

17. A method of operating a battery comprising a Li metal negative electrode and an electrolyte, wherein the method comprises heating the Li metal negative electrode to an annealing temperature at which Li dendrites are not formed or are removed.

18. The method of claim 17, wherein the annealing temperature is greater than or equal to 160° C. and less than or equal to 200° C.

19. The method of claim 17, wherein the Li metal negative electrode and electrolyte are separated by an interlayer comprising a fully reduced material selected from the group consisting of nitrides, phosphides, oxides, sulfides and halides.
